(19) United States
(12) Patent Application Publication
(10) Pub. No.: US 2019/0089939 A1
(43) Pub. Date: Mar. 21, 2019

(54) DEPTH SENSOR OPTIMIZATION BASED ON DETECTED DISTANCE

(71) Applicant: Intel Corporation, Santa Clara, CA (US)

(72) Inventor: Yen Hsiang Chew, Georgetown (MY)

(73) Assignee: Intel Corporation, Santa Clara, CA (US)

(21) Appl. No.: 15/708,020

(22) Filed: Sep. 18, 2017

(51) Int. Cl. H04N 13/02; H04N 5/33; G01B 11/22

(52) U.S. Cl. CPC H04N 13/0296; H04N 13/0242; G01B 11/22; H04N 5/33; H04N 13/0253; H04N 13/025

(57) ABSTRACT

Described are mechanisms for depth sensor optimization based on detected distances. The mechanisms may comprise a distance measurement module, which may be operable to measure a physical distance between a 3D camera sensor and a person or object in view of the 3D camera. The mechanisms may also comprise a sensor mode selector module, which may be operable to select a best camera sensor configuration based on a measured distance from a distance-measurement module.

### BACKGROUND

Some depth sensing 3D cameras may utilize only a single depth sensing method on a camera module irrespective of a distance between the camera module and a person or object of interest in its camera view.

Some cameras of a first type may utilize an infrared projection and reflected infrared pattern sensing method for forming 3D images. Some such cameras may have a higher 3D pixel resolution more suitable for use in hand or gesture interaction, and face landmark feature extraction, but may be less suitable for use in drone or robot navigation due to is limited range.

Some cameras of a second type may utilize a stereo vision method for forming 3D images. Some such cameras may have longer range which may be more suitable for drone and robot navigation, but may have a lower image resolution at short range, and may therefore be less suitable for hand gesture detection and face landmark feature extraction.

Various sensing technology configurations may have differing optimum ranges for best quality image acquisition.

### BRIEF DESCRIPTION OF THE DRAWINGS

The embodiments of the disclosure will be understood more fully from the detailed description given below and from the accompanying drawings of various embodiments of the disclosure. However, while the drawings are to aid in explanation and understanding, they are only an aid, and should not be taken to limit the disclosure to the specific embodiments depicted therein.

FIG. 1 illustrates a high level block diagram of a camera and a computing device, in accordance with some embodiments of the disclosure.

FIG. 2 illustrates exemplary camera sensor configurations, in accordance with some embodiments of the disclosure.

FIG. 3 illustrates exemplary depth region partitions, in accordance with some embodiments of the disclosure.

FIG. 4 illustrates exemplary depth region partitions, in accordance with some embodiments of the disclosure.

FIG. 5 illustrates exemplary usage scenarios, in accordance with some embodiments of the disclosure.

FIG. 6 illustrates an exemplary algorithm flow diagram, in accordance with some embodiments of the disclosure.

FIG. 7 illustrates a computing device with mechanisms for depth sensor optimization based on detected distances, in accordance with some embodiments of the disclosure.

### DETAILED DESCRIPTION

Conventionally, depth sensing methods for 3D camera sensors may be fixed, and may not dynamically change based on a detected distance between a 3D camera and a person or object of interest. A system may be disposed to picking a camera and designing a usage model for the system based on the camera's depth sensing capabilities. For example, if one camera is picked, then it may be used for long range user body part interaction and not short range hand interaction or face analysis. If another, different camera is picked, it may be used for short range facial analysis and hand interaction, but may not be suitable for use in longer range applications.

Previous solutions may limit effective usage models of 3D cameras. A first disadvantage is that a 3D camera configured for short range depth sensing may not be effectively used for user applications that require a longer range and vice versa. For example, some applications only work on some cameras and some on other cameras, but not both. Some cameras are more suitable for longer range machine to human interaction and not shorter range hand gesture interaction and face analysis.

A second disadvantage is that usage models enabling both short and long range sensing may be disposed to incorporate multiple types of camera hardware modules. For example, robots disposed to performing navigation, face analytics, and hand gesture interaction may be disposed to installing multiple 3D camera sensors (e.g., a long range 3D camera for navigation, and a shorter range but higher resolution 3D camera for face analytics and hand gesture interactions).

A third disadvantage is that some solutions may not provide desirably optimized 3D image sensing capabilities for end users during user interaction. For example, end users may not be aware of an optimum sensing distance between themselves and a camera sensor. Being too close or too far away from a 3D camera sensor may negatively impact an ability of the camera's 3D image sensor to effectively acquire a 3D image, which may negatively impact user experience.

In some embodiments, the mechanisms and methods disclosed herein may enable a depth-sensing 3D camera to dynamically reconfigure its sensors based on a detected distance between the camera sensor and a person or an object of interest in its camera view, in order to have the most optimized range and image quality for capturing a 3D image of the person or object.

In various embodiments, these mechanisms and methods may advantageously dynamically reconfigure and optimize a 3D camera for use in a wide variety (or even all) short-range and long-range applications; advantageously enable a single camera hardware to be used across a wide variety (or even all) short-range and long-range applications; and advantageously automatically reconfigure a 3D camera sensor based on a measured distance between the sensor and a user or object of interest, which may in turn optimize 3D image acquisition quality.

In various embodiments, these mechanisms and methods may further be employed to enhance various 3D cameras; to optimize various 3D image sensors in support of robot navigation and short range user interactions; and to enhance future generations of camera depth sensing technology.

In the following description, numerous details are discussed to provide a more thorough explanation of embodiments of the present disclosure. It will be apparent to one skilled in the art, however, that embodiments of the present disclosure may be practiced without these specific details. In other instances, well-known structures and devices are shown in block diagram form, rather than in detail, in order to avoid obscuring embodiments of the present disclosure.

Note that in the corresponding drawings of the embodiments, signals are represented with lines. Some lines may be thicker, to indicate a greater number of constituent signal paths, and/or have arrows at one or more ends, to indicate a direction of information flow. Such indications are not intended to be limiting. Rather, the lines are used in connection with one or more exemplary embodiments to facilitate easier understanding of a circuit or a logical unit. Any represented signal, as dictated by design needs or preferences, may actually comprise one or more signals that may travel in either direction and may be implemented with any suitable type of signal scheme.

Throughout the specification, and in the claims, the term “connected” means a direct electrical, mechanical, or magnetic connection between the things that are connected, without any intermediary devices. The term “coupled” means either a direct electrical, mechanical, or magnetic connection between the things that are connected or an indirect connection through one or more passive or active intermediary devices. The term “circuit” or “module” may refer to one or more passive and/or active components that are arranged to cooperate with one another to provide a desired function. The term “signal” may refer to at least one current signal, voltage signal, magnetic signal, or data/clock signal. The meaning of “a,” “an,” and “the” include plural references. The meaning of “in” includes “in” and “on.”

The terms “substantially,” “close,” “approximately,” “near,” and “about” generally refer to being within +/−10% of a target value. Unless otherwise specified the use of the ordinal adjectives “first,” “second,” and “third,” etc., to describe a common object, merely indicate that different instances of like objects are being referred to, and are not intended to imply that the objects so described must be in a given sequence, either temporally, spatially, in ranking, or in any other manner.

It is to be understood that the terms so used are interchangeable under appropriate circumstances such that the embodiments of the invention described herein are, for example, capable of operation in other orientations than those illustrated or otherwise described herein.

The terms “left,” “right,” “front,” “back,” “top,” “bottom,” “over,” “under,” and the like in the description and in the claims, if any, are used for descriptive purposes and not necessarily for describing permanent relative positions.

For purposes of the embodiments, the transistors in various circuits, modules, and logic blocks are Tunneling FETs (TFETs). Some transistors of various embodiments may comprise metal oxide semiconductor (MOS) transistors, which include drain, source, gate, and bulk terminals. The transistors may also include Tri-Gate and FinFET transistors, Gate All Around Cylindrical Transistors, Square Wire, or Rectangular Ribbon Transistors or other devices implementing transistor functionality like carbon nanotubes or spintronic devices. MOSFET symmetrical source and drain terminals i.e., are identical terminals and are interchangeably used here. A TFET device, on the other hand, has asymmetric Source and Drain terminals. Those skilled in the art will appreciate that other transistors, for example, Bi-polar junction transistors-BJT PNP/NPN, BiCMOS, CMOS, etc., may be used for some transistors without departing from the scope of the disclosure.

For the purposes of the present disclosure, the phrases “A and/or B” and “A or B” mean (A), (B), or (A and B). For the purposes of the present disclosure, the phrase “A, B, and/or C” means (A), (B), (C), (A and B), (A and C), (B and C), or (A, B and C).

In addition, the various elements of combinatorial logic and sequential logic discussed in the present disclosure may pertain both to physical structures (such as AND gates, OR gates, or XOR gates), or to synthesized or otherwise optimized collections of devices implementing the logical structures that are Boolean equivalents of the logic under discussion.

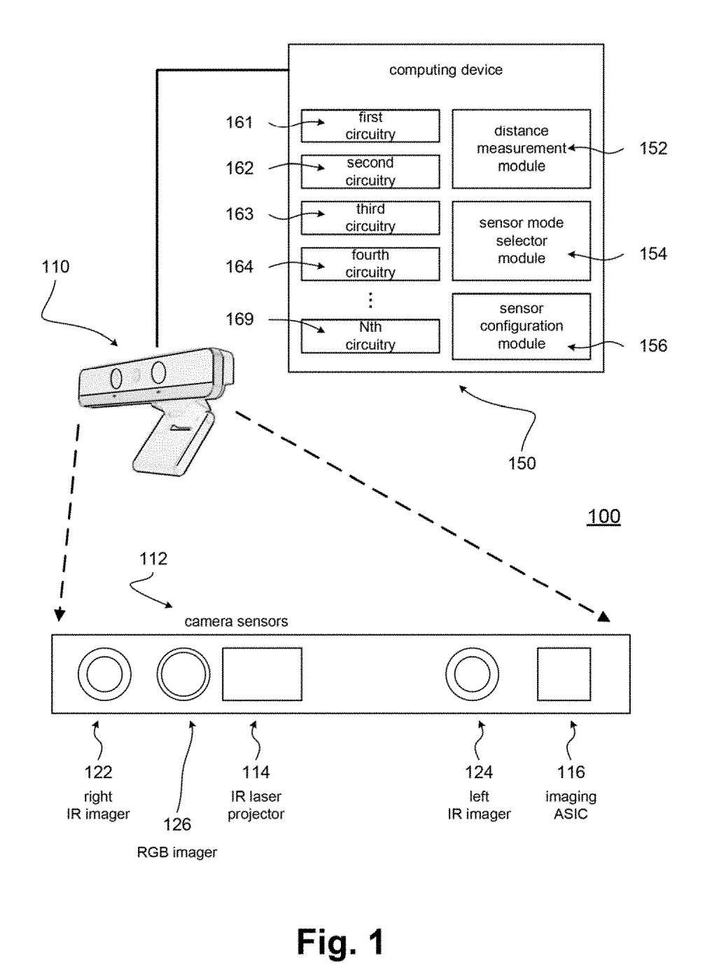

FIG. 1 illustrates a high level block diagram of a camera and a computing device, in accordance with some embodiments of the disclosure. A design 100 may comprise a camera 110 and may comprise a computing device 150. In some embodiments, camera 110 and computing device may be integrated into a single apparatus or device, while in other embodiments, camera 110 and computing device150 may not be integrated within a single apparatus or device.

Camera 110 may comprise a set of camera sensors 112, which may in turn comprise one or more infrared (IR) imagers, such as a right IR imager 122 and a left IR imager 124, and/or a red-green-blue (RGB) imager 126. Camera 110 (and/or camera sensors 112) may also comprise an IR laser projector 114 and/or an imaging Application-Specific Integrated Circuit (ASIC) 116. Camera 110 may be a three-dimensional (3D) camera, and one or more of camera sensors 112 may be 3D camera sensors.

Computing device 150 may comprise a distance measurement module 152, a sensor mode selector module 154, and a sensor configuration module 156. Distance measurement module 152 may be operable to measure a physical distance between a 3D camera sensor and a person or object in view of the 3D camera. Sensor mode selector module 154, in cooperation with sensor configuration module 156, may be operable to select a best camera sensor configuration based on a measured distance from a distance-measurement module.

Computing device 150 may also comprise a variety of circuitries coupled to camera 110 (and/or the components thereof), distance measurement module 152, sensor mode selector module 154, and/or sensor configuration module 156. For example, computing device 150 may comprise a first circuitry 161, a second circuitry 162, a third circuitry 163, a fourth circuitry 164, and/or a variety of other circuitries, up to an Nth circuitry 169.

In various embodiments, an apparatus in accordance with design 100 may comprise first circuitry 161, second circuitry 162, third circuitry 163, and/or fourth circuitry 164. First circuitry 161 may be operable to obtain a first image, and may correspond to a first range of distances between the apparatus and an external object. Second circuitry 162 may be operable to obtain a second image, and may correspond to a second range of distances between the apparatus and the external object. Third circuitry 163 may be operable to optically determine a distance between the apparatus and the external object (e.g., based upon an image obtained by one or more of camera sensors 112). Fourth circuitry 164 may be operable to configure the apparatus, based on the determined distance, for one of: a first mode associated with the first range of distances, and a second mode associated with the second range of distances.

In some embodiments, at least a portion of the first range of distances may extend outward from the apparatus further than the second range of distances. In some embodiments, at least a portion of the second range of distances may extend inward towards the apparatus further than the first range of distances (e.g., the second range of distances may come closer to the apparatus than the first range of distances). For some embodiments, substantially an entirety of the first range of distances may extend outward from the apparatus further than the second range of distances.

For some embodiments, the first circuitry may be coupled to two imagers (e.g., to right IR imager 122 and/or to left IR imager 124) operable to obtain a depth image and/or a distance determination between the imagers and a person or object using a first sensing method (e.g., a stereoscopic image sensing method). In some embodiments, one of the two imagers may be coupled to second circuitry 162 when the apparatus is configured for the second mode. The second mode imager may be operable to obtain a depth image and/or a distance determination between the imager and a person or object using a second sensing method (e.g., a structured light sensing method). In some embodiments, the apparatus in accordance with design 100 may additionally comprise a fifth circuitry to project light, and second circuitry 162 may be coupled to an imager operable to obtain at least one of: a color image, an intensity image, and a depth image (e.g., RGB imager 126, right IR imager 122, and/or left IR imager 124).

In some embodiments, third circuitry 163 may be operable to optically determine the distance based upon a third image obtained by first circuitry 161 and/or second circuitry 162. For some embodiments, the first mode may be a longer-range mode than the second mode.

For various embodiments, an apparatus in accordance with design 100 may comprise first circuitry 161, second circuitry 162, third circuitry 163, and/or fourth circuitry 164. First circuitry 161 may be operable to obtain a first image, and may have a first range of distances between the apparatus and an external object. The first range of distances may be associated with an imaging quality level of the first image. Second circuitry 162 may be operable to obtain a second image, and may have a second range of distances between the apparatus and the external object. The second range of distances may be associated with an imaging quality level of the second image. Third circuitry 163 may be operable to optically determine a distance between the apparatus and the external object. Fourth circuitry 164 may be operable to select between the first image and the second image based on the determined distance.

In some embodiments, at least a portion of the first range of distances may extend outward from the apparatus further than the second range of distances. In some embodiments, at least a portion of the second range of distances may extend inward towards the apparatus further than the first range of distances (e.g., the second range of distances may come closer to the apparatus than the first range of distances). For some embodiments, first circuitry 161 may be coupled to two imagers for obtaining a depth image and/or or a distance determination between the imagers and a person or object using a first sensing method (e.g., a stereoscopic image sensing method). In some embodiments, the apparatus in accordance with design 100 may comprise an additional circuitry to project light, and one of the two imagers may be coupled to second circuitry 162 when the apparatus is configured for the second mode. The second mode imager may be operable to obtain a depth image and/or a distance determination between the imager and a person or object using a second sensing method (e.g., a structured light sensing method).

For some embodiments, second circuitry 162 may be coupled to an imager operable to obtain at least one of: a color image, an intensity image, and a depth image (e.g., RGB imager 126, right IR imager 122, and/or left IR imager 124). In some embodiments, third circuitry 163 may be operable to optically determine the distance based upon a third image obtained by first circuitry 161 and/or second circuitry 162.

For some embodiments, the apparatus may comprise one or more multiplexed signal paths. When fourth circuitry 164 selects the first image, the one or more multiplexed signal paths may be coupled to one or more first wires bearing the first image. When fourth circuitry 164 selects the second image, the one or more multiplexed signal paths may be coupled to one or more second wires bearing the second image.

In some embodiments, a sensing method for distance determination may be based on predetermined information regarding a size of a person or object. For example, computing device 150 may know information regarding an average size of an adult person's head, or an average height of an adult person. Face tracking or person tracking may then be used to determine the presence of a person in front of a camera, and one or more of a size of a person's head and a height of a person may potentially serve as a basis for estimating a distance of the person from a camera.

A size of a person's head or a height of a person may be acquired using a sensor such as an RGB sensor (e.g., a two-dimensional light sensor) without needing to obtain a depth image or otherwise obtaining a 3D depth measurement, such as a measurement obtained using stereo vision imagers, or a measurement obtained using a structured light sensing imager. Despite potential error margins, such methods of estimating depth may advantageously be used for very long distance depth estimation, which may be distances at which depth measurement using other depth sensing methods may be difficult.

In some embodiments, a sensing method for distance determination may comprise other methods, which may include (without being limited to) a sheet-of-light triangulation method, a coded aperture method, a light-assisted active stereo vision method, a passive stereo vision method, an interferometry method, a time-of-flight measurement method, a depth-from-focus method, and/or a stereo-camera or multi-camera/multi-imager triangulation method.

In some embodiments, a single imager (e.g. right IR imager 122, left IR imager 124, and/or RGB imager 126) may be reconfigurable to acquire images from either an RGB spectrum or an IR light spectrum. In some embodiments, a single imager (e.g. right IR imager 122, left IR imager 124, and/or RGB imager 126) may be operable to acquire images from both an RGB spectrum and an IR light spectrum.

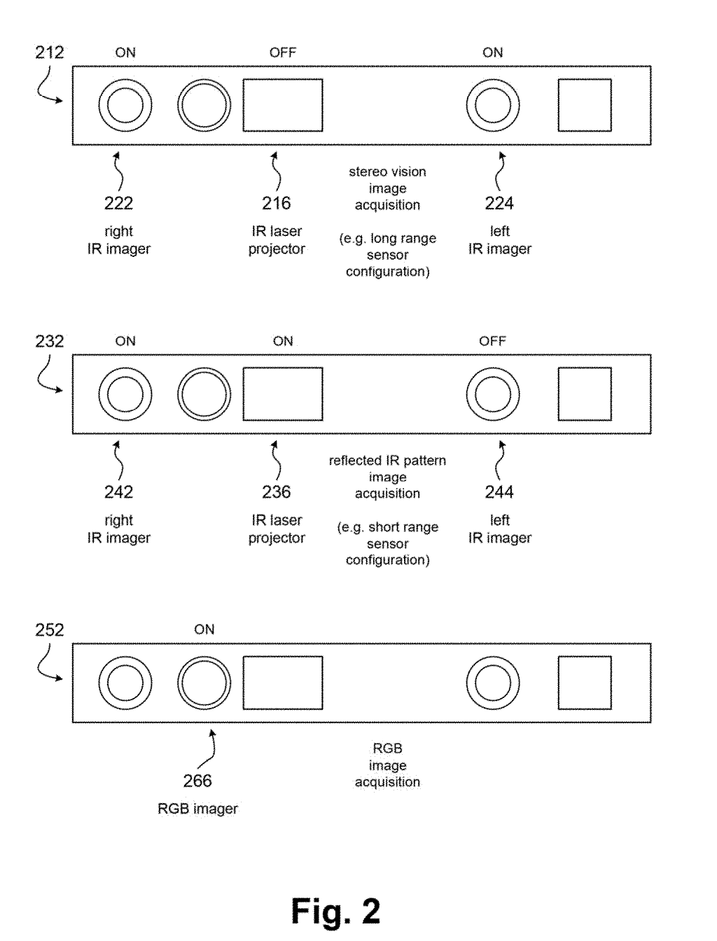

FIG. 2 illustrates exemplary camera sensor configurations, in accordance with some embodiments of the disclosure. In a first scenario, a camera may comprise camera sensors 212, which may in turn comprise a right IR imager 222 and/or a left IR imager 224. The camera (and/or camera sensors 212) may also comprise an IR laser projector 216. In the first scenario, both right IR imager 222 and left IR imager 224 may be on, while IR laser projector 216 may be off. The camera and/or camera sensors 212 may accordingly be configured to acquire a depth image (e.g., using a stereo vision image sensing method).

In a second scenario, a camera may comprise camera sensors 232, which may in turn comprise a right IR imager 242 and/or a left IR imager 244. The camera (and/or camera sensors 232) may also comprise an IR laser projector 236. In the second scenario, one of right IR imager 242 or left IR imager 244 may be on, while IR laser projector 236 may be on. The camera and/or camera sensors 232 may accordingly be configured to acquire a depth image (e.g., using a structured light sensing method).

In a third scenario, a camera may comprise camera sensors 252, which may in turn comprise an RGB imager 266. In the third scenario, RGB imager 266 may be on. The camera and/or camera sensors 252 may accordingly be configured to acquire a color image (e.g., for a distance determination based on a size of a person or object).

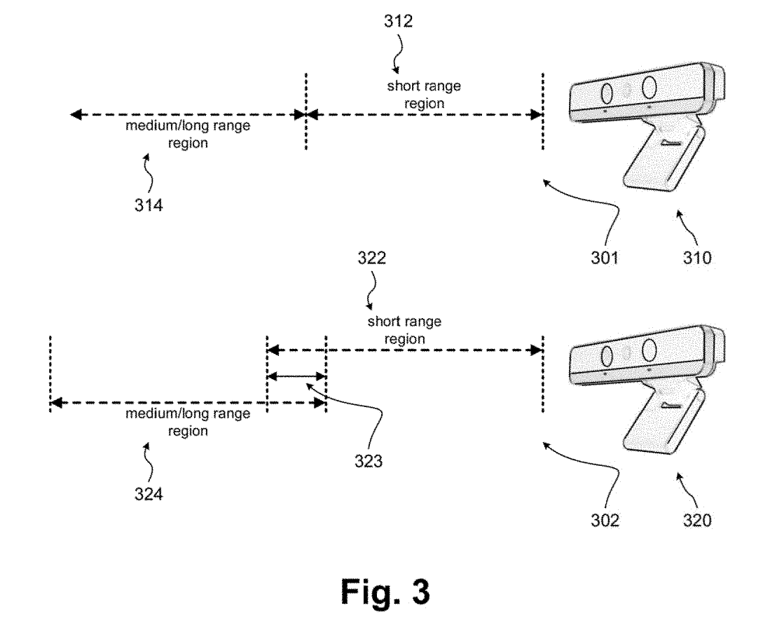

FIG. 3 illustrates exemplary depth region partitions, in accordance with some embodiments of the disclosure. In a first scenario 301, a camera 310 may comprise various camera sensors and/or circuitries coupled to the camera sensors which may correspond with a first range of distances and a second range of distances. Accordingly, camera 310 may have a short range region 312 associated with the first range of distances, and may have a medium range and/or long range region 314 associated with the second range of distances. Short range region 312 and medium range and/or long range region 314 might not overlap.

In a second scenario 302, a camera 320 may comprise various camera sensors and/or circuitries coupled to the camera sensors which may correspond with a first range of distances and a second range of distances. Accordingly, camera 320 may have a short range region 322 associated with the first range of distances, and may have a medium range and/or long range region 324 associated with the second range of distances. In contrast with first scenario 310, short range region 322 and medium range region 324 may share an overlapping region. For example, short range region 322 and medium range and/or long range region 324 may overlap in an overlapping region 323. In various embodiments, the ranges may overlap, which may advantageously counteract excessive dithering when measured depth values are close to depth region boundaries.

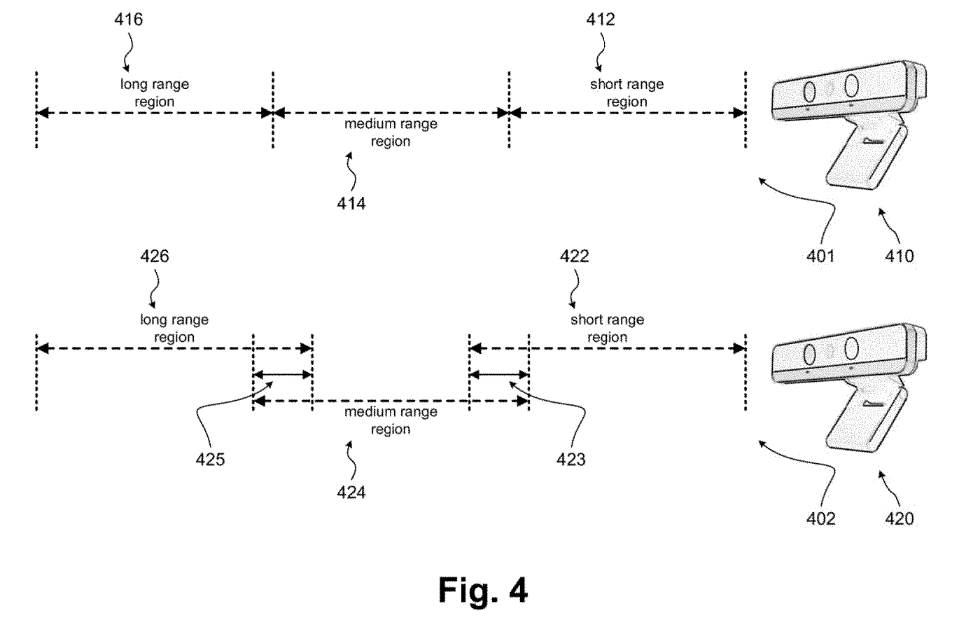

In various alternate embodiments, a camera comprising camera sensors and/or circuitries coupled to the camera sensors may correspond with more than two ranges of distances. FIG. 4 illustrates exemplary depth region partitions, in accordance with some embodiments of the disclosure. In a first scenario 401, a camera 410 may comprise various camera sensors and/or circuitries coupled to the camera sensors which may correspond with a first range of distances, a second range of distances, and a third range of distances. Accordingly, camera 410 may have a short range region 412 associated with the first range of distances, may have a medium range region 414 associated with the second range of distances, and may have a long range region 416 associated with the third range of distances. Short range region 412, medium range region 414, and long range region 416 might not overlap.

In a second scenario 402, a camera 420 may comprise various camera sensors and/or circuitries coupled to the camera sensors which may correspond with a first range of distances, a second range of distances, and a third range of distances. Accordingly, camera 420 may have a short range region 422 associated with the first range of distances, may have a medium range region 424 associated with the second range of distances, and may have a long range region 426 associated with the third range of distances. In contrast with first scenario 401, short range region 422, medium range region 424, and long range region 426 may share overlapping regions. For example, short range region 422 and medium range region 424 may overlap in a first overlapping region 423, and medium range region 424 and long range region 426 may overlap in a second overlapping region 425. In various embodiments, one or more of the ranges may overlap, which may advantageously counteract excessive dithering when measured depth values are close to depth region boundaries. In various alternate embodiments, a camera comprising camera sensors and/or circuitries coupled to the camera sensors may correspond with more than 3 ranges of distances.

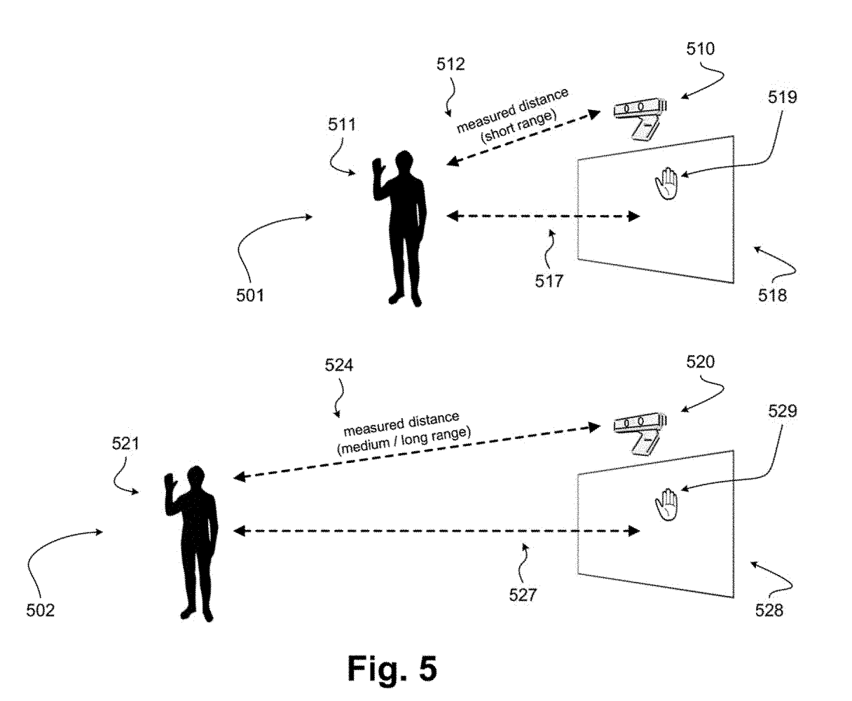

FIG. 5 illustrates exemplary usage scenarios, in accordance with some embodiments of the disclosure. In a first scenario 501, a camera 510 mounted to or otherwise associated with a screen 518 (e.g., a computing system, or a kiosk) may interact with a person (or object) 511. Camera 510 may determine a measured distance 512 between camera 510 and person (or object) 511 (such as by operation of a distance measurement module of a computing device coupled to camera 510), which may in turn stand in for a distance 517 between person (or object) 511 and screen 518.

In first scenario 501, measured distance 512 may fall within a short range of distances for camera 510 (e.g., a range of distances associated with a short-range mode of camera 510). Distance 517 may accordingly be determined to be a short range distance, and camera 510 may be configured and/or may otherwise select one or more imagers for use in obtaining depth images or distance measurements based upon the suitability of the one or more imagers for the short range distance (e.g., for a distance within the short-range mode of camera 510). A computing device coupled to camera 510 may then produce interactive content based on the obtained images, and may display the interactive content on screen 518.

In a second scenario 502, a camera 520 mounted to or otherwise associated with a screen 528 (e.g., a computing system, or a kiosk) may interact with a person (or object) 521. Camera 520 may determine a measured distance 524 between camera 520 and person (or object) 521 (such as by operation of a distance measurement module of a computing device coupled to camera 520), which may in turn stand in for a distance 527 between person (or object) 521 and screen 528.

In second scenario 502, measured distance 524 may fall within a medium/long range of distances for camera 520 (e.g., a range of distances associated with a medium/long range mode of camera 520). Distance 527 may accordingly be determined to be a medium/long range distance, and camera 520 may be configured and/or may otherwise select one or more imagers for use in obtaining images based upon the suitability of the one or more imagers for the medium/long range distance (e.g., for a distance within the medium/long range mode of camera 520). A computing device coupled to camera 520 may then produce interactive content based on the obtained images, and may display the interactive content on screen 528.

With reference to FIGS. 1 through 5, in various embodiments, a 3D camera, which may be part of a computing system or coupled to a computing system, may be set to a default long range mode (e.g., for stereo vision image acquisition with no infrared projection). The 3D camera may continuously monitor a distance between one or more camera sensors and a person or object in its camera view.

If a measured distance between the camera sensor and the person or object falls within a predetermined depth region (e.g., a short range depth region), the computing system may reconfigure the camera to a shorter range and/or higher resolution sensing mode (e.g., by disabling stereo vision image capture and/or by enabling infrared projection, since a 3D image may be formed by detecting reflected infrared patterns using a single imaging sensor of the camera and/or a structured light sensing method). The 3D camera may continue to measure the distance between the camera sensor and the person or object.

When a measured distance falls within a second predetermined depth region (e.g., a long range depth region), the computing system may reconfigure the camera to a long range sensing mode (e.g., by disabling infrared projection and/or by enabling stereo vision image capture).

In various embodiments, more than two camera modes and depth range regions may be supported. For example, some embodiments may support more than a single short-range depth region and a single long-range depth region.

During operation of a 3D camera, when no person or object is in front of the camera, a sensor mode selector module of a computing device coupled to the camera may set a depth sensor of the 3D camera to a default long range depth sensing mode. For example, the sensor mode selector module may enable both a left image sensor and a right image sensor to perform a stereo vision image acquisition with no infrared projection. The 3D camera may monitor for people or objects in its camera view.

When a person or object enters the camera view of the 3D camera, a distance measurement module of the computing device may continuously measure a distance between the person or object and the camera depth sensors. When the measured distance falls within a predefined depth region (e.g., within a short range depth region), the computing system may reconfigure a 3D camera sensor to a short range, high resolution depth sensing mode (e.g., by disabling stereo vision image capture, and/or by enabling infrared projection; a 3D image may be formed by detecting reflected infrared patterns using a single imaging sensor of the 3D camera and/or a structured light sensing method). A 3D camera acquired depth image may be used for close-range hand control or gesture control and/or face analytics in some such configurations.

A distance measurement module of the computing device may continuously measure the distance between the person or object and the camera depth sensors. When the measured distance falls within a second predefined depth region (e.g., a long range depth region), the computing system may reconfigure the 3D camera back to a long range depth sensing mode (e.g., by disabling infrared projection, and/or by re-enabling stereo vision).

In various embodiments, multiple camera modes and depth regions (e.g., more than 2) may be utilized. For example, a 3D camera may have a short range, depth sensing mode, a medium range depth sensing mode, and a long range depth sensing mode, and multiple depth regions and/or depth region boundaries may be used to facilitate switching between the three depth sensing modes.

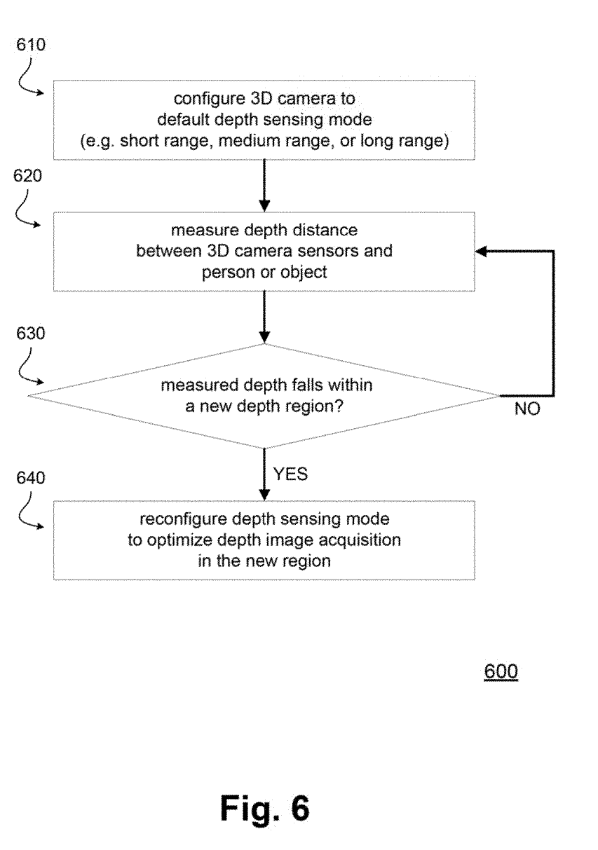

FIG. 6 illustrates an exemplary algorithm flow diagram, in accordance with some embodiments of the disclosure. An algorithm 600 may comprise a configuring 610, a measuring 620, an evaluation 630, and a reconfiguring 640.

In configuring 610, a 3D camera may be configured to a default depth sensing mode (e.g., a short range mode, or a medium range mode, or a long range mode). In measuring 620, a depth distance between one or more 3D camera sensors of the 3D camera and a person or object may be measured. In evaluation 630, the measured depth may be evaluated to determine whether it falls within a new depth region. If the measured depth falls within a new depth region, then in reconfiguring 640, the depth sensing mode may be reconfigured to optimize depth image acquisition in the new region. Otherwise, if the measured depth does not fall within a new depth region, then in measuring 620, a depth distance between the one or more 3D camera sensors of the 3D camera and the person or object may be measured again.

Accordingly, in various embodiments, a method may comprise a first configuring (e.g., configuring 610), a measuring (e.g., measuring 620), a determining (e.g., in evaluation 630), and a second configuring (e.g., reconfiguring 640). In the first configuring, a camera may be configured to a first sensing mode. In the measuring, a distance between a camera and an external object may be measured. In the determining, a determination may be made as to whether the distance falls within a range of distances corresponding to a second sensing mode. In the second configuring, the camera may be configured to the second sensing mode if the distance falls within the range of distances corresponding to the second sensing mode.

In some embodiments, the method may comprise a first selecting and/or a second selecting. In the first selecting, a first image obtained by a first circuitry at a first range of distances between the camera and an external object may be selected in the first sensing mode. In the second selecting, a second image obtained by a second circuitry at a second range of distances between the camera and the external object may be selected in the second sensing mode. For some embodiments, the first image may be a depth image acquired using a first method and/or a first set of imagers. For some embodiments, the second image may be a color image, an intensity image, or a depth image acquired using a second method and/or a second set of imagers.

For some embodiments, a range of distances corresponding to the first sensing mode may at least partially overlap the range of distances corresponding to the second sensing mode.

Although the actions in the flowchart with reference to FIG. 6 are shown in a particular order, the order of the actions can be modified. Thus, the illustrated embodiments can be performed in a different order, and some actions may be performed in parallel. Some of the actions and/or operations listed in FIG. 6 are optional in accordance with certain embodiments. The numbering of the actions presented is for the sake of clarity and is not intended to prescribe an order of operations in which the various actions must occur. Additionally, operations from the various flows may be utilized in a variety of combinations.

In some embodiments, an apparatus may comprise means for performing various actions and/or operations of the methods of FIG. 6.

Moreover, in some embodiments, machine readable storage media may have executable instructions that, when executed, cause one or more processors to perform an operation comprising algorithm 600. Such machine readable storage media may include any of a variety of storage media, like magnetic storage media (e.g., magnetic tapes or magnetic disks), optical storage media (e.g., optical discs), electronic storage media (e.g., conventional hard disk drives, solid-state disk drives, or flash-memory-based storage media), or any other tangible storage media or non-transitory storage media.

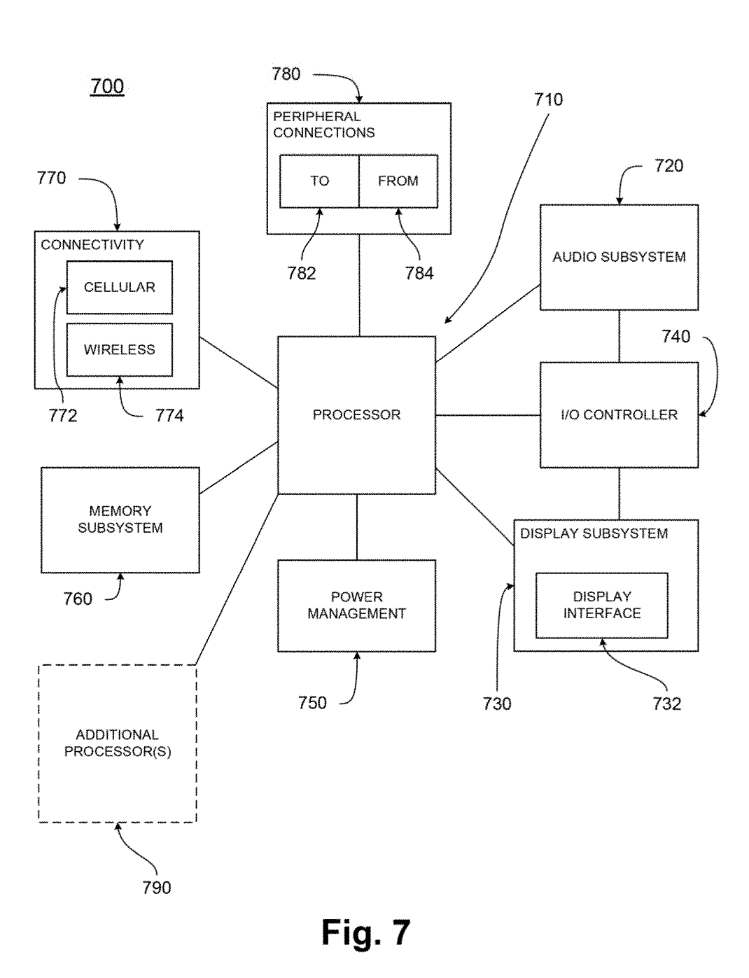

FIG. 7 illustrates a computing device with mechanisms for depth sensor optimization based on detected distances, in accordance with some embodiments of the disclosure. Computing device 700 may be a computer system, a System-on-a-Chip (SoC), a tablet, a mobile device, a smart device, or a smart phone with mechanisms for depth sensor optimization based on detected distances, in accordance with some embodiments of the disclosure. It will be understood that certain components of computing device 700 are shown generally, and not all components of such a device are shown FIG. 7. Moreover, while some of the components may be physically separate, others may be integrated within the same physical package, or even on the same physical silicon die. Accordingly, the separation between the various components as depicted in FIG. 7 may not be physical in some cases, but may instead be a functional separation. It is also pointed out that those elements of FIG. 7 having the same names or reference numbers as the elements of any other figure can operate or function in any manner similar to that described, but are not limited to such.

In various embodiments, the components of computing device 700 may include any of a processor 710, an audio subsystem 720, a display subsystem 730, an I/O controller 740, a power management component 750, a memory subsystem 760, a connectivity component 770, one or more peripheral connections 780, and one or more additional processors 790. In some embodiments, processor 710 may include mechanisms for depth sensor optimization based on detected distances, in accordance with some embodiments of the disclosure. In various embodiments, however, any of the components of computing device 700 may include the mechanisms for depth sensor optimization based on detected distances, in accordance with some embodiments of the disclosure. In addition, one or more components of computing device 700 may include an interconnect fabric having a plurality of ports, such as a router, a network of routers, or a Network-on-a-Chip (NoC).

In some embodiments, computing device 700 may be a mobile device which may be operable to use flat surface interface connectors. In one embodiment, computing device 700 may be a mobile computing device, such as a computing tablet, a mobile phone or smart-phone, a wireless-enabled e-reader, or other wireless mobile device. The various embodiments of the present disclosure may also comprise a network interface within 770 such as a wireless interface so that a system embodiment may be incorporated into a wireless device, for example a cell phone or personal digital assistant.

Processor 710 may be a general-purpose processor or CPU (Central Processing Unit). In some embodiments, processor 710 may include one or more physical devices, such as microprocessors, application processors, microcontrollers, programmable logic devices, or other processing means. The processing operations performed by processor 710 may include the execution of an operating platform or operating system on which applications and/or device functions may then be executed. The processing operations may also include operations related to one or more of the following: audio I/O; display I/O; power management; connecting computing device 700 to another device; and/or I/O (input/output) with a human user or with other devices.

Audio subsystem 720 may include hardware components (e.g., audio hardware and audio circuits) and software components (e.g., drivers and/or codecs) associated with providing audio functions to computing device 700. Audio functions can include speaker and/or headphone output as well as microphone input. Devices for such functions can be integrated into computing device 700, or connected to computing device 700. In one embodiment, a user interacts with computing device 700 by providing audio commands that are received and processed by processor 710.

Display subsystem 730 may include hardware components (e.g., display devices) and software components (e.g., drivers) that provide a visual and/or tactile display for a user to interact with computing device 700. Display subsystem 730 may include a display interface 732, which may be a particular screen or hardware device used to provide a display to a user. In one embodiment, display interface 732 includes logic separate from processor 710 to perform at least some processing related to the display. In some embodiments, display subsystem 730 includes a touch screen (or touch pad) device that provides both output and input to a user.

I/O controller 740 may include hardware devices and software components related to interaction with a user. I/O controller 740 may be operable to manage hardware that is part of audio subsystem 720 and/or display subsystem 730. Additionally, I/O controller 740 may be a connection point for additional devices that connect to computing device 700, through which a user might interact with the system. For example, devices that can be attached to computing device 700 might include microphone devices, speaker or stereo systems, video systems or other display devices, keyboard or keypad devices, or other I/O devices for use with specific applications such as card readers or other devices.

As mentioned above, I/O controller 740 can interact with audio subsystem 720 and/or display subsystem 730. For example, input through a microphone or other audio device can provide input or commands for one or more applications or functions of computing device 700. Additionally, audio output can be provided instead of, or in addition to, display output. In another example, if display subsystem 730 includes a touch screen, the display device may also act as an input device, which can be at least partially managed by I/O controller 740. There can also be additional buttons or switches on computing device 700 to provide I/O functions managed by I/O controller 740.

In some embodiments, I/O controller 740 manages devices such as accelerometers, cameras, light sensors or other environmental sensors, or other hardware that can be included in computing device 700. The input can be part of direct user interaction, and may provide environmental input to the system to influence its operations (such as filtering for noise, adjusting displays for brightness detection, applying a flash for a camera, or other features).

Power management component 750 may include hardware components (e.g., power management devices and/or circuitry) and software components (e.g., drivers and/or firmware) associated with managing battery power usage, battery charging, and features related to power saving operation.

Memory subsystem 760 may include one or more memory devices for storing information in computing device 700. Memory subsystem 760 can include nonvolatile memory devices (whose state does not change if power to the memory device is interrupted) and/or volatile memory devices (whose state is indeterminate if power to the memory device is interrupted). Memory subsystem 760 can store application data, user data, music, photos, documents, or other data, as well as system data (whether long-term or temporary) related to the execution of the applications and functions of computing device 700.

Some portion of memory subsystem 760 may also be provided as a non-transitory machine-readable medium for storing the computer-executable instructions (e.g., instructions to implement any other processes discussed herein). The machine-readable medium may include, but is not limited to, flash memory, optical disks, CD-ROMs, DVD ROMs, RAMs, EPROMs, EEPROMs, magnetic or optical cards, phase change memory (PCM), or other types of machine-readable media suitable for storing electronic or computer-executable instructions. For example, some embodiments of the disclosure may be downloaded as a computer program (e.g., BIOS) which may be transferred from a remote computer (e.g., a server) to a requesting computer (e.g., a client) by way of data signals via a communication link (e.g., a modem or network connection).

Connectivity component 770 may include a network interface, such as a cellular interface 772 or a wireless interface 774 (so that an embodiment of computing device 700 may be incorporated into a wireless device such as a cellular phone or a personal digital assistant). In some embodiments, connectivity component 770 includes hardware devices (e.g., wireless and/or wired connectors and communication hardware) and software components (e.g., drivers and/or protocol stacks) to enable computing device 700 to communicate with external devices. Computing device 700 could include separate devices, such as other computing devices, wireless access points or base stations, as well as peripherals such as headsets, printers, or other devices.

In some embodiments, connectivity component 770 can include multiple different types of network interfaces, such as one or more wireless interfaces for allowing processor 710 to communicate with another device. To generalize, computing device 700 is illustrated with cellular interface 772 and wireless interface 774. Cellular interface 772 refers generally to wireless interfaces to cellular networks provided by cellular network carriers, such as provided via GSM or variations or derivatives, CDMA (code division multiple access) or variations or derivatives, TDM (time division multiplexing) or variations or derivatives, or other cellular service standards. Wireless interface 774 refers generally to non-cellular wireless interfaces, and can include personal area networks (such as Bluetooth, Near Field, etc.), local area networks (such as Wi-Fi), and/or wide area networks (such as WiMax), or other wireless communication.

Peripheral connections 780 may include hardware interfaces and connectors, as well as software components (e.g., drivers and/or protocol stacks) to make peripheral connections. It will be understood that computing device 700 could both be a peripheral device to other computing devices (via “to” 782), as well as have peripheral devices connected to it (via “from” 784). The computing device 700 may have a “docking” connector to connect to other computing devices for purposes such as managing content on computing device 700 (e.g., downloading and/or uploading, changing, synchronizing). Additionally, a docking connector can allow computing device 700 to connect to certain peripherals that allow computing device 700 to control content output, for example, to audiovisual or other systems.

In addition to a proprietary docking connector or other proprietary connection hardware, computing device 700 can make peripheral connections 780 via common or standards-based connectors. Common types of connectors can include a Universal Serial Bus (USB) connector (which can include any of a number of different hardware interfaces), a DisplayPort or MiniDisplayPort (MDP) connector, a High Definition Multimedia Interface (HDMI) connector, a Firewire connector, or other types of connectors.

Accordingly, in various embodiments, the mechanisms and methods discussed herein may enable a depth sensing 3D camera to automatically reconfigure one or more depth sensors based on measured distances between the camera sensors and people or objects of interest (e.g., within a camera view of the 3D camera), and may thereby maximize an image acquisition quality across a wider depth range.

The mechanisms and methods discussed herein may advantageously be utilized to dynamically reconfigure a 3D camera sensor so that a single camera module may support both short range and long range applications.

The mechanisms and methods discussed herein may also advantageously provide enhanced user experiences for systems utilizing 3D image sensing technologies. In some embodiments, when a user is close to a screen (e.g., a computing system, or a kiosk) with a mounted 3D image sensor, the image sensor may be configured for short range 3D image acquisition; and when the user is further away from the screen, the 3D image sensor may be automatically reconfigured for medium or long range 3D image acquisition. This may advantageously reduce user frustration when interacting with systems incorporating 3D cameras, since users may not be aware of the optimal distance between themselves and the system for best 3D image capture.

Reference in the specification to “an embodiment,” “one embodiment,” “some embodiments,” or “other embodiments” means that a particular feature, structure, or characteristic described in connection with the embodiments is included in at least some embodiments, but not necessarily all embodiments. The various appearances of “an embodiment,” “one embodiment,” or “some embodiments” are not necessarily all referring to the same embodiments. If the specification states a component, feature, structure, or characteristic “may,” “might,” or “could” be included, that particular component, feature, structure, or characteristic is not required to be included. If the specification or claim refers to “a” or “an” element, that does not mean there is only one of the elements. If the specification or claims refer to “an additional” element, that does not preclude there being more than one of the additional element.

Furthermore, the particular features, structures, functions, or characteristics may be combined in any suitable manner in one or more embodiments. For example, a first embodiment may be combined with a second embodiment anywhere the particular features, structures, functions, or characteristics associated with the two embodiments are not mutually exclusive.

While the disclosure has been described in conjunction with specific embodiments thereof, many alternatives, modifications and variations of such embodiments will be apparent to those of ordinary skill in the art in light of the foregoing description. For example, other memory architectures e.g., Dynamic RAM (DRAM) may use the embodiments discussed. The embodiments of the disclosure are intended to embrace all such alternatives, modifications, and variations as to fall within the broad scope of the appended claims.

In addition, well known power/ground connections to integrated circuit (IC) chips and other components may or may not be shown within the presented figures, for simplicity of illustration and discussion, and so as not to obscure the disclosure. Further, arrangements may be shown in block diagram form in order to avoid obscuring the disclosure, and also in view of the fact that specifics with respect to implementation of such block diagram arrangements are highly dependent upon the platform within which the present disclosure is to be implemented (i.e., such specifics should be well within purview of one skilled in the art). Where specific details (e.g., circuits) are set forth in order to describe example embodiments of the disclosure, it should be apparent to one skilled in the art that the disclosure can be practiced without, or with variation of, these specific details. The description is thus to be regarded as illustrative instead of limiting.

The following examples pertain to further embodiments. Specifics in the examples may be used anywhere in one or more embodiments. All optional features of the apparatus described herein may also be implemented with respect to a method or process.

An example provides an apparatus comprising: a first circuitry to obtain a first image, the first circuitry corresponding to a first range of distances between the apparatus and an external object; a second circuitry to obtain a second image, the second circuitry corresponding to a second range of distances between the apparatus and the external object; a third circuitry to optically determine a distance between the apparatus and the external object; and a fourth circuitry to configure the apparatus, based on the determined distance, for one of: a first mode associated with the first range of distances, and a second mode associated with the second range of distances.

Some embodiments provide an apparatus wherein at least a portion of the first range of distances extends outward from the apparatus further than the second range of distances.

Some embodiments provide an apparatus wherein substantially an entirety of the first range of distances extends outward from the apparatus further than the second range of distances.

Some embodiments provide an apparatus wherein the first circuitry is coupled to two imagers operable to obtain a stereoscopic image.

Some embodiments provide an apparatus wherein one of the two imagers is coupled to the second circuitry when the apparatus is configured for the second mode.

Some embodiments provide an apparatus comprising: a fifth circuitry to proj ect light.

Some embodiments provide an apparatus, wherein the second circuitry is coupled to an imager operable to obtain at least one of: a color image, an intensity image, and a depth image.

Some embodiments provide an apparatus wherein the third circuitry is to optically determine the distance based upon a third image obtained by one of: the first circuitry, and the second circuitry.

Some embodiments provide an apparatus wherein the first mode is a longer-range mode than the second mode.

Some embodiments provide an apparatus wherein the first range of distances is associated with an image quality level of the first image, and the second range of distances is associated with an image quality level of the second image.

Some embodiments provide a system comprising a memory, a processor coupled to the memory, and a wireless interface for allowing the processor to communicate with another device, the system including the apparatus of any of the examples discussed herein.

An example provides an apparatus comprising: a first circuitry to obtain a first image, the first circuitry having a first range of distances between the apparatus and an external object, the first range of distances being associated with an imaging quality level of the first image; a second circuitry to obtain a second image, the second circuitry having a second range of distances between the apparatus and the external object, the second range of distances being associated with an imaging quality level of the second image; a third circuitry to optically determine a distance between the apparatus and the external object; and a fourth circuitry to select between the first image and the second image based on the determined distance.

Some embodiments provide an apparatus wherein at least a portion of the first range of distances extends outward from the apparatus further than the second range of distances.

Some embodiments provide an apparatus wherein the first circuitry is coupled to two imagers for obtaining a stereoscopic image.

Some embodiments provide an apparatus comprising: a fifth circuitry to project light, wherein one of the two imagers is coupled to the second circuitry when the apparatus is configured for the second mode.

Some embodiments provide an apparatus wherein the second circuitry is coupled to an imager operable to obtain at least one of: a color image, an intensity image, and a depth image.

Some embodiments provide an apparatus wherein the third circuitry is to optically determine the distance based upon a third image obtained by one of: the first circuitry, and the second circuitry.

Some embodiments provide an apparatus wherein the apparatus comprises one or more multiplexed signal paths; wherein, when the fourth circuitry selects the first image, the one or more multiplexed signal paths are coupled to one or more first wires bearing the first image; and wherein, when the fourth circuitry selects the second image, the one or more multiplexed signal paths are coupled to one or more second wires bearing the second image.

Some embodiments provide a system comprising a memory, a processor coupled to the memory, and a wireless interface for allowing the processor to communicate with another device, the system including the apparatus of the examples discussed herein.

An example provides a system comprising a memory, a processor coupled to the memory, and a wireless interface for allowing the processor to communicate with another device, the processor including: a first circuitry to obtain a first image, the first circuitry corresponding to a first range of distances between the apparatus and an external object; a second circuitry to obtain a second image, the second circuitry corresponding to a second range of distances between the apparatus and the external object; a third circuitry to optically determine a distance between the apparatus and the external object; and a fourth circuitry to configure the apparatus, based on the determined distance, for one of: a first mode associated with the first range of distances, and a second mode associated with the second range of distances.

Some embodiments provide a system wherein at least a portion of the first range of distances extends outward from the apparatus further than the second range of distances; and wherein the first mode is a longer-range mode than the second mode.

Some embodiments provide a system wherein the first circuitry is coupled to two first imagers operable to obtain a stereoscopic image; and wherein the second circuitry is coupled to an imager operable to obtain at least one of: a color image, an intensity image, and a depth image.

Some embodiments provide a system , comprising: a fifth circuitry to project light, wherein one of the two imagers is coupled to the second circuitry when the apparatus is configured for the second mode.

An example provides a method comprising: configuring a camera to a first sensing mode; measuring a distance between a camera and an external object; determining whether the distance falls within a range of distances corresponding to a second sensing mode; and configuring the camera to the second sensing mode if the distance falls within the range of distances corresponding to the second sensing mode.

Some embodiments provide a method comprising: selecting, in the first sensing mode, a first image obtained by a first circuitry at a first range of distances between the camera and an external object; selecting, in the second sensing mode, a second image obtained by a second circuitry at a second range of distances between the camera and the external object.

Some embodiments provide a method wherein the first image is one of: a color image, an intensity image, and a depth image acquired using a first method or a first set of imagers.

Some embodiments provide a method wherein the second image is one of: a color image, an intensity image, and a depth image acquired using one of: a second method, or a second set of imagers.

Some embodiments provide a method wherein a range of distances corresponding to the first sensing mode at least partially overlaps the range of distances corresponding to the second sensing mode.

Some embodiments provide a machine readable storage medium having machine executable instructions stored thereon that, when executed, cause one or more processors to perform a method the examples discussed herein.

An example provides an apparatus comprising: means for configuring a camera to a first sensing mode; means for measuring a distance between a camera and an external object; means for determining whether the distance falls within a range of distances corresponding to a second sensing mode; and means for configuring the camera to the second sensing mode if the distance falls within the range of distances corresponding to the second sensing mode.

Some embodiments provide an apparatus comprising: means for selecting, in the first sensing mode, a first image obtained by a first circuitry at a first range of distances between the camera and an external object; means for selecting, in the second sensing mode, a second image obtained by a second circuitry at a second range of distances between the camera and the external object.

Some embodiments provide an apparatus wherein the first image is one of: a color image, an intensity image, and a depth image acquired using a first method or a first set of imagers.

Some embodiments provide an apparatus wherein the second image is one of: a color image, an intensity image, and a depth image acquired using one of: a second method, or a second set of imagers.

Some embodiments provide an apparatus wherein a range of distances corresponding to the first sensing mode at least partially overlaps the range of distances corresponding to the second sensing mode.

An example provides a machine readable media having machine executable instructions stored thereon that, when executed, cause one or more processors to perform an operation comprising: configure a camera to a first sensing mode; measure a distance between a camera and an external object; determine whether the distance falls within a range of distances corresponding to a second sensing mode; and configure the camera to the second sensing mode if the distance falls within the range of distances corresponding to the second sensing mode.

Some embodiments provide a machine readable storage media the operation comprising: select, in the first sensing mode, a first image obtained by a first circuitry at a first range of distances between the camera and an external object; select, in the second sensing mode, a second image obtained by a second circuitry at a second range of distances between the camera and the external object.

Some embodiments provide a machine readable storage media wherein the first image is one of: a color image, an intensity image, and a depth image acquired using a first method or a first set of imagers.

Some embodiments provide a machine readable storage media wherein the second image is one of: a color image, an intensity image, and a depth image acquired using one of: a second method, or a second set of imagers.

Some embodiments provide a machine readable storage media wherein a range of distances corresponding to the first sensing mode at least partially overlaps the range of distances corresponding to the second sensing mode.

An abstract is provided that will allow the reader to ascertain the nature and gist of the technical disclosure. The abstract is submitted with the understanding that it will not be used to limit the scope or meaning of the claims. The following claims are hereby incorporated into the detailed description, with each claim standing on its own as a separate embodiment.

I claim:

1. An apparatus comprising:
a first circuitry to obtain a first image, the first circuitry corresponding to a first range of distances between the apparatus and an external object;
a second circuitry to obtain a second image, the second circuitry corresponding to a second range of distances between the apparatus and the external object;
a third circuitry to optically determine a distance between the apparatus and the external object; and
a fourth circuitry to configure the apparatus, based on the determined distance, for one of: a first mode associated with the first range of distances, and a second mode associated with the second range of distances.

2. The apparatus of claim 1,
wherein at least a portion of the first range of distances extends outward from the apparatus further than the second range of distances.

3. The apparatus of claim 1,
wherein substantially an entirety of the first range of distances extends outward from the apparatus further than the second range of distances.

4. The apparatus of claim 1,
wherein the first circuitry is coupled to two imagers operable to obtain a stereoscopic image.

5. The apparatus of claim 4,
wherein one of the two imagers is coupled to the second circuitry when the apparatus is configured for the second mode.

6. The apparatus of claim 4, comprising:
a fifth circuitry to project light.

7. The apparatus of claim 1,
wherein the second circuitry is coupled to an imager operable to obtain at least one of: a color image, an intensity image, and a depth image.

8. The apparatus of claim 1,
wherein the third circuitry is to optically determine the distance based upon a third image obtained by one of: the first circuitry, and the second circuitry.

9. The apparatus of claim 1,
wherein the first mode is a longer-range mode than the second mode.

10. An apparatus comprising:
a first circuitry to obtain a first image, the first circuitry having a first range of distances between the apparatus and an external object, the first range of distances being associated with an imaging quality level of the first image;
a second circuitry to obtain a second image, the second circuitry having a second range of distances between the apparatus and the external object, the second range of distances being associated with an imaging quality level of the second image;
a third circuitry to optically determine a distance between the apparatus and the external object; and
a fourth circuitry to select between the first image and the second image based on the determined distance.

11. The apparatus of claim 10,
wherein at least a portion of the first range of distances extends outward from the apparatus further than the second range of distances.

12. The apparatus of claim 10,
wherein the first circuitry is coupled to two imagers for obtaining a stereoscopic image.

13. The apparatus of claim 12, comprising:
a fifth circuitry to project light,
wherein one of the two imagers is coupled to the second circuitry when the apparatus is configured for the second mode.

14. The apparatus of claim 10,
wherein the second circuitry is coupled to an imager operable to obtain at least one of: a color image, an intensity image, and a depth image.

15. The apparatus of claim 10,
wherein the third circuitry is to optically determine the distance based upon a third image obtained by one of: the first circuitry, and the second circuitry.

16. The apparatus of claim 10,
wherein the apparatus comprises one or more multiplexed signal paths;
wherein, when the fourth circuitry selects the first image, the one or more multiplexed signal paths are coupled to one or more first wires bearing the first image; and
wherein, when the fourth circuitry selects the second image, the one or more multiplexed signal paths are coupled to one or more second wires bearing the second image.

17. A system comprising a memory, a processor coupled to the memory, and a wireless interface for allowing the processor to communicate with another device, the processor including:
a first circuitry to obtain a first image, the first circuitry corresponding to a first range of distances between the apparatus and an external object;
a second circuitry to obtain a second image, the second circuitry corresponding to a second range of distances between the apparatus and the external object;
a third circuitry to optically determine a distance between the apparatus and the external object; and
a fourth circuitry to configure the apparatus, based on the determined distance, for one of: a first mode associated with the first range of distances, and a second mode associated with the second range of distances.

18. The system of claim 17,
wherein at least a portion of the first range of distances extends outward from the apparatus further than the second range of distances; and
wherein the first mode is a longer-range mode than the second mode.

19. The system of claim 17,
wherein the first circuitry is coupled to two first imagers operable to obtain a stereoscopic image; and
wherein the second circuitry is coupled to an imager operable to obtain at least one of: a color image, an intensity image, and a depth image.

20. The system of claim 19, comprising:
a fifth circuitry to project light,
wherein one of the two imagers is coupled to the second circuitry when the apparatus is configured for the second mode.
